(19) United States
(12) Patent Application Publication
(10) Pub. No.: US 2018/0040153 A1
(43) Pub. Date: Feb. 8, 2018

(54) ANNOTATION METHOD, ANNOTATION SYSTEM, AND RECORDING MEDIUM STORING PROGRAM

(71) Applicant: Panasonic Intellectual Property Corporation of America, Torrance, CA (US)

(72) Inventors: TORU TANIGAWA, Osaka (JP); YUKIE SHODA, Osaka (JP); TETSUJI FUCHIKAMI, Osaka (JP)

(21) Appl. No.: 15/644,859

(22) Filed: Jul. 10, 2017

(30) Foreign Application Priority Data
Aug. 4, 2016 (JP) 2016-154059
Apr. 28, 2017 (JP) 2017-090612

(51) Int. Cl. G06T 11/60; G06T 3/00

(52) U.S. Cl. CPC G06T 11/60; G06T 3/0018

(57) ABSTRACT

In an annotation method for a fisheye image, a fisheye image is acquired, a transformed image is generated by performing perspective projection transformation of the fisheye image, the transformed image is presented to an operator who performs annotation, input of annotation information regarding annotation performed on the transformed image is received from the operator, transformation of coordinate information included in the input annotation information and regarding the annotation in the transformed image into information regarding coordinates in the fisheye image is performed, and the annotation information resulting from the transformation is recorded as fisheye-image annotation information regarding the annotation in the fisheye image.

### BACKGROUND

### 1. Technical Field

The present disclosure relates to an annotation method for a fisheye image, an annotation system, and a recording medium storing a program.

### 2. Description of the Related Art

In constructing or the like of learning data for performing machine learning, annotation such as labelling is performed on image data in order to identify the image data. For example, Japanese Unexamined Patent Application Publication No. 2013-161295 discloses a technique for labelling image data.

### SUMMARY

Annotation is performed on an entity such as a person or an object included in an image. Data of an image captured with a fisheye lens is used for annotation in some cases, and the image captured with the fisheye lens is a coaxial image. Entities in the image captured with the fisheye lens are arranged radially from the center of a concentric circle and thus at locations in various directions. Accordingly, it is laborious to perform processing for defining the area of an entity to be annotated in the image,

One non-limiting and embodiment provides an annotation method, an annotation system, and a program that simplify annotation of a fisheye image that is an image captured with a fisheye lens.

In one general aspect, the techniques disclosed here feature an annotation method for a fisheye image. In the annotation method, a fisheye image is acquired, a transformed image is generated by performing perspective projection transformation of the fisheye image, the transformed image is presented to an operator who performs annotation, input of annotation information regarding annotation performed on the transformed image is received from the operator, transformation of coordinate information included in the input annotation information and regarding the annotation in the transformed image into information regarding coordinates in the fisheye image is performed, and the annotation information resulting from the transformation is recorded as fisheye-image annotation information regarding the annotation in the fisheye image.

The annotation method, an annotation system, and a recording medium storing a program according to the present disclosure and the like enable annotation to be simply performed on a fisheye image.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a room image captured with an omnidirectional video camera installed on the ceiling of a room;

FIG. 2 is a diagram illustrating an example of a transformed image obtained by performing perspective projection transformation of the captured image in FIG. 1;

FIG. 3 is a diagram illustrating a relationship between the captured image in FIG. 1 and the transformed image in FIG. 2;

FIG. 4 is a block diagram schematically illustrating the configuration of an annotation system according to the embodiment;

FIG. 5 is a flowchart illustrating the operation of the annotation system according to the embodiment;

FIG. 6 is a diagram illustrating annotation to be performed on a fisheye image of a parking lot captured with an onboard camera that is an omnidirectional video camera;

FIG. 7 is a diagram illustrating annotation that the same as the annotation in FIG. 6 and that is to be performed on a panorama image obtained by performing perspective projection transformation of the fisheye image in FIG. 6; and

FIG. 8 is a flowchart illustrating the operation of the annotation system according to Modification 1.

### DETAILED DESCRIPTION

### Underlying Knowledge Forming Basis of the Present Disclosure

To increase the accuracy of detection and identification of entities including a person in an image, the inventors of the present disclosure have studied the use of technology involving neural networks, such as deep learning. The identification of an entity in the deep learning needs a large volume of learning image data. In the learning image data, information including the content, the location, the area, and the like of the entity is added to the entity as annotation information, that is, the entity is annotated. Generally, when an entity is annotated, a person performs an input operation on the image such as making a selection around the entity in the image, and the area of the entity is thereby set.

The inventors have studied the use of digital image data extracted from digital video, as a large volume of image data to be annotated. In particular, to obtain a large volume of image data, the inventors have studied the use of video captured with a capturing apparatus that captures video over a long time, such as a monitoring camera or an onboard camera. An omnidirectional camera is used as the monitoring camera or the onboard camera in some cases to enable capturing of a wide-range image. The omnidirectional camera includes an optical system such as a fisheye lens, a conical mirror, a polygonal pyramid mirror, a spherical mirror, or a hyperboloid mirror and is capable of capturing an image in all directions at a time, that is, 360 degrees, by using the optical system.

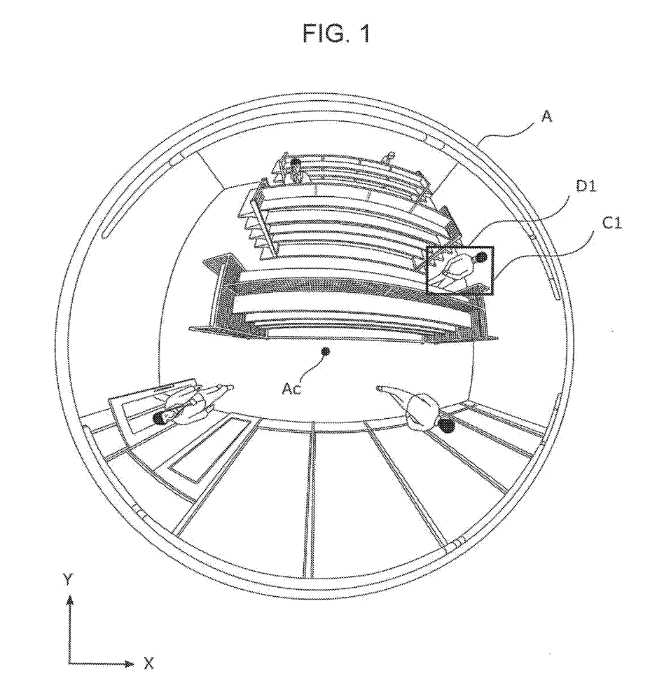

For example, FIG. 1 illustrates an example of an image captured with an omnidirectional video camera including a fisheye lens. Note that FIG. 1 illustrates an example of a room image captured with the omnidirectional video camera installed on the ceiling of a room. A fisheye lens is a lens employing projection that is not central projection. A captured image A of a circular shape in FIG. 1 is a coaxial image, and captured entities are distorted in the circumference of the captured image A with a center Ac located as the center. The omnidirectional video camera has the fisheye lens facing downward and captures an image of the room from the top. For example, persons standing on the same floor in the captured image A are displayed as if they were lying down to extend outward in the radial direction from the center Ac.

In a case where a person C1 in the captured image A is annotated, the captured image A is displayed on the screen of the display device of a computer (not illustrated) or the like, and an annotation operator sets an area for the person C1 on the screen. At this time, to facilitate setting of the area and identification of the location and the range of the area, a rectangular frame D1 is generally used to set the area for the person C1. The rectangular frame D1 surrounds the person C1 and has sides extending in horizontal and vertical directions. Note that the horizontal direction is a direction that extends laterally along the screen of the display device or the like of the computer and is an X-axis direction in FIG. 1 The vertical direction is a direction that extends along the screen of the display device or the like of the computer and that is perpendicular to the horizontal direction. The vertical direction is a Y-axis direction in FIG. 1. The locations of the person C1, the rectangular frame D1, and the like may be expressed using an orthogonal coordinate system having coordinate axes of the X and Y axes in FIG. 1 or a polar coordinate system using the length and angle of a radius vector originating from the center Ac.

Since the directions of the sides of the rectangular frame D1 obliquely cross an upright direction, that is, a height direction of the person C1, the rectangular frame D1 includes not only an area for the person C1 but also other areas not for the person C1. Accordingly, if an area in the rectangular frame D1 is used for the computer to identify a data image, a person in the data image might not be identified as a person, and an element that is not the person in the data image might be identified as a person.

Accordingly, the inventors have studied technology for reducing inclusion of elements other than an entity that is a person or the like in a rectangular frame in a case where a rectangular frame is used to set the area of the entity. The inventors have found that if perspective projection transformation of the captured image A is performed, elements can be arranged in substantially the same direction in the captured image A, for example, persons and objects on the same floor can be arranged to be upright in the substantially vertical direction, that is, in the Y-axis direction.

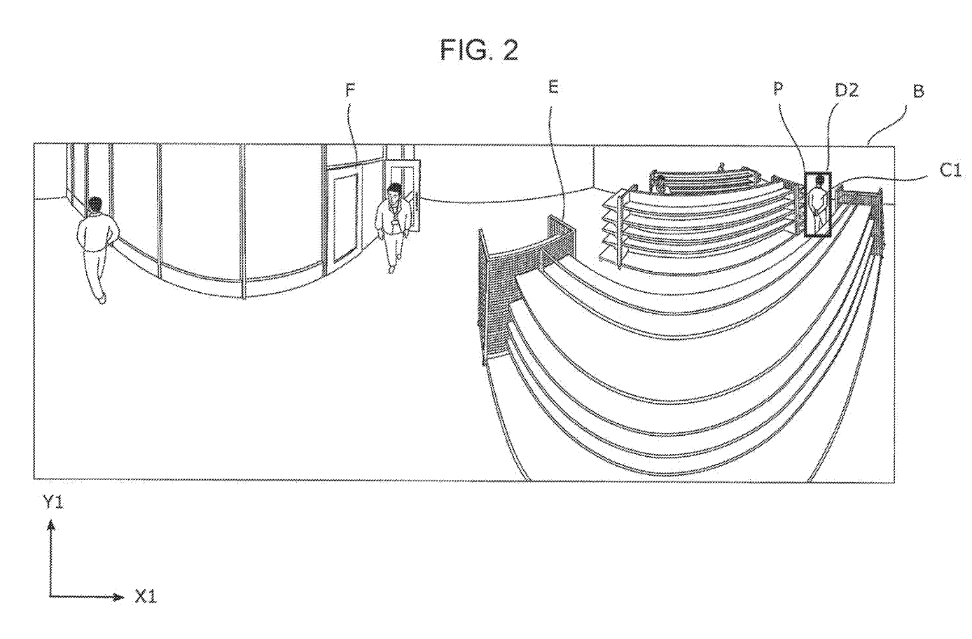

FIG. 2 illustrates a transformed image B resulting from perspective projection transformation of the captured image A. FIG. 2 is a diagram illustrating the transformed image B that is an example image obtained by performing the perspective projection transformation of the captured image A in FIG. 1. With reference to FIG. 2, the transformed image B that is a panorama image includes a plurality of persons including the person C1, the vertical braces of a shelf E, the vertically extending frame of a door F, and the like that are substantially vertically upright. Accordingly, a rectangular frame D2 surrounding the person C1 extends around the person C1 and can be set to reduce the number of elements other than the person C1 in the frame D2. In the transformed image B in FIG. 2, the X1 axis is set laterally and longitudinally, the Y1 axis is set along the transformed image B and perpendicular to the X1 axis, and an orthogonal coordinate system with the X1 and Y1 axes as coordinate axes is set. The rectangular frame D2 may be formed easily in such a manner that each of the sides is set to extend along a corresponding one of the X1 and Y1 axes.

The perspective projection transformation from the captured image A into the transformed image B will be described. In the perspective projection transformation from the captured image A into the transformed image B, the captured image A is transformed so as to be projected onto the surface of a cylinder surrounding the captured image A, and a panorama image is thereby generated. The panorama image corresponds to the transformed image B. Projecting the captured image A onto the cylinder surface is also referred to as panorama development. In the panorama development, transformation from polar coordinates to orthogonal coordinates is used. Although various types of transformation from polar coordinates to orthogonal coordinates are known, any type of transformation from polar coordinates to orthogonal coordinates may be used.

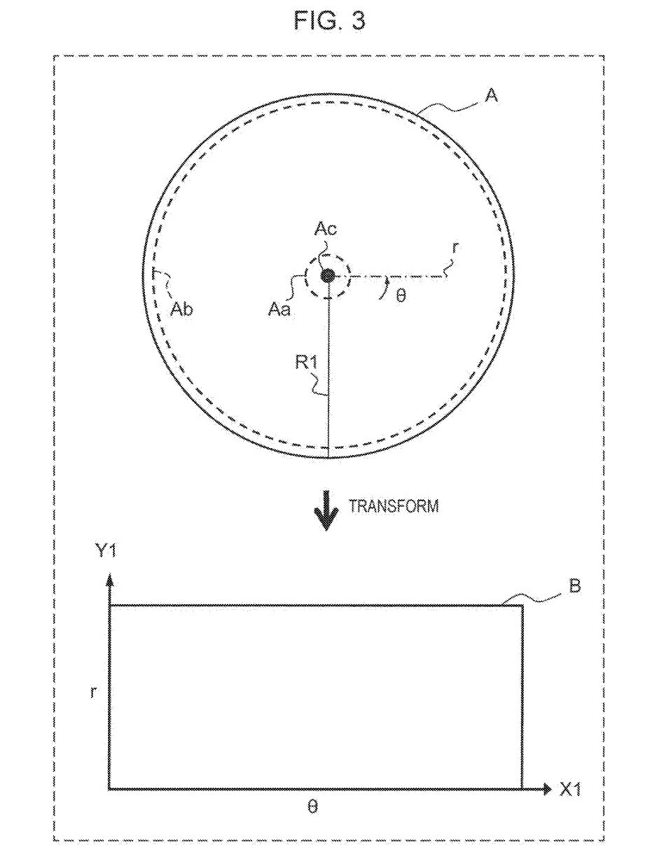

For example, in simple transformation from polar coordinates to orthogonal coordinates as illustrated in FIG. 3, pixels are sampled at a regular pitch in each of a radial r direction and a circumferential θ direction on the polar coordinates of the captured image A in a polar coordinate notation (r, θ). Further, each sampled pixel is rearranged in a matrix in accordance with a value of θ in the X1-axis direction and a value of r in the Y1-axis direction, and the transformed image B having undergone the panorama development is thereby generated. The transformed image B is generated in such a manner that the captured image A is developed with respect to a radius part R1 extending from the center Ac and that a region close to the center Ac and indicated by a broken line is expanded.

In addition, log-polar transform is also applicable to the transformation from polar coordinates to orthogonal coordinates. Specifically, each pixel sampled from the captured image A is rearranged in a matrix in accordance with the value of θ in the X1-axis direction and a log of the value of r in the Y1-axis direction, and the transformed image B is thereby generated. The aspect ratio of the transformed image B thereby becomes more accurate with respect to the actual image.

The inventors also made the following finding. When the captured image A is transformed into the transformed image B in the aforementioned manner, the area near the center Ac of the captured image A is enlarged in the transformed image B at a higher ratio than that for the other area, and the transformed image B is thus distorted to a further extent. It is thus preferable to develop a region outside of a circle Aa extending outward in the radial direction, the circle Aa being away from the center Ac outwardly in the radial direction.

In addition, since a region near the outer edge of the captured image A is largely distorted, a captured entity in the region is not distinguishable in some cases. Further, the region near the outer edge of the captured image A is influenced by an area outside the captured image A at the time of perspective projection transformation. Accordingly, the inventors also made the following finding. When the captured image A is transformed into the transformed image B in the aforementioned manner, it is preferable to develop a region inside of a circle Ab extending inward in the radial direction, the circle Ab being away from the outer edge of the captured image A inwardly in the radial direction.

Hereinafter, the embodiment disclosed by the inventors based on the various findings described above will be specifically described with reference to the drawings. The embodiment to be described below represents general or specific examples of the present disclosure. Numerical values, shapes, materials, components, arrangement locations and a connection mode of the components, steps, the order of the steps, and the like that are described in the embodiment below are merely examples and do not limit the present disclosure. If a component that is not described in an independent claim corresponding to the highest level description of the present disclosure is described in the following embodiment, the component is described as an optional component. Ordinal numbers such as first, second, and third may appropriately added to the components or the like in the expressions of the embodiment.

In the following description of the embodiment, a phrase using “substantially” such as substantially parallel or substantially orthogonal is used in some cases. For example, the term “substantially parallel” denotes not only a completely parallel state but also a substantially parallel state, that is, inclusion of, for example, a small percent difference. The same holds true for the other phrases using “substantially”. The drawings are schematic diagrams and are not necessarily strictly illustrated. Further, the substantially the same components are denoted by the same reference numerals, and overlapping explanations are omitted or simplified in some cases.

### Embodiment

### Configuration of Annotation System

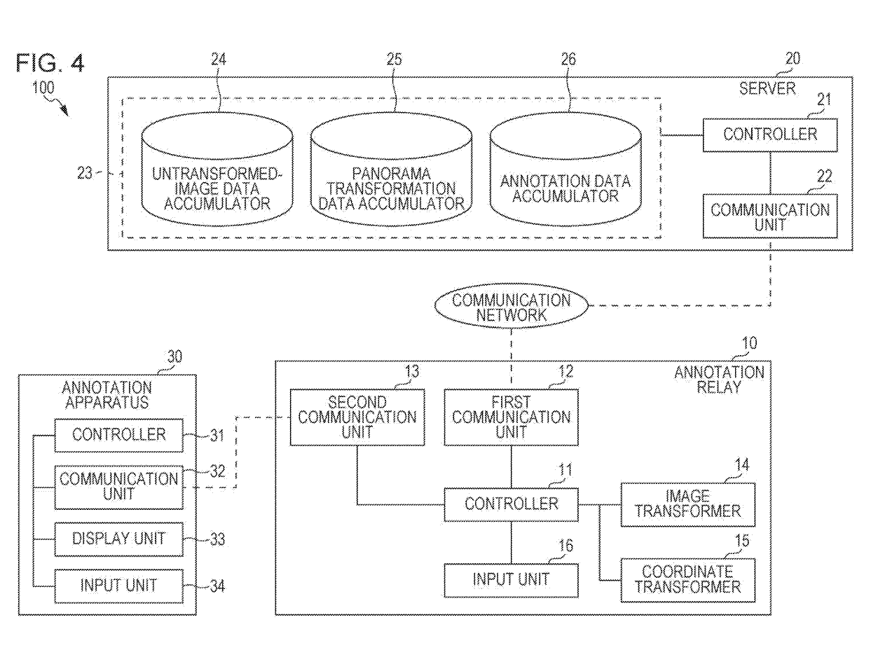

The configuration of an annotation system 100 according to the embodiment will be described with reference to FIG. 4. FIG. 4 is a block diagram schematically illustrating the configuration of the annotation system 100 according to the embodiment. The annotation system 100 includes an annotation relay 10, a server 20, and an annotation apparatus 30. The server 20 accumulates various pieces of data. The annotation apparatus 30 annotates an image. The annotation relay 10 acquires an image to be annotated from the server 20, transforms the image, transmits the resultant image to the annotation apparatus 30, receives information regarding the annotation from the annotation apparatus 30, transmits the image to the server 20 in association with the information, and performs other operations. Specifically, being located between the server 20 and the annotation apparatus 30, the annotation relay 10 changes and relays information.

The server 20 is configured to communicate with the annotation relay 10. The server 20 may be an information processing apparatus such as a computer. The server 20 may include one or more servers and may be configured as a cloud system. The server 20 includes a controller 21 that performs overall control of the server 20, a communication unit 22 that communicates with the annotation relay 10, and a data accumulator 23 that accumulates various pieces of data. The communication unit 22 communicates with the annotation relay 10 through a communication network such as the Internet. The communication unit 22 may be a communication circuit including a communication interface. For example, a wireless local area network (LAN) such as wireless fidelity (Wi-Fi) (registered trademark) may be used for the communication between the communication unit 22 and the annotation relay 10. Wired communication using a cable may also be performed. Other wireless or wired communications may also be performed.

The data accumulator 23 is configured of, for example, a hard disk and includes an untransformed-image data accumulator 24, a panorama transformation data accumulator 25, and an annotation data accumulator 26. The untransformed-image data accumulator 24 stores therein images captured with various image capturing apparatuses. Specifically, fisheye images captured with an image capturing apparatus including a fisheye lens are stored. A fisheye image may be an image captured through a circular fisheye lens or a diagonal fisheye lens. In the diagonal fisheye lens, the diameter of an image circle that is a circular range where an image is formed by light passing through the lens is larger than the diagonal lines of a rectangular captured image. In the circular fisheye lens, the diameter of the image circle is larger than the dimensions of the captured image in the respective horizontal and vertical directions.

The panorama transformation data accumulator 25 stores therein, as panorama transformation data, the details of perspective projection transformation performed on a fisheye image in the untransformed-image data accumulator 24, such as a parameter, a table, and data used for the perspective projection transformation. Alternatively, the panorama transformation data accumulator 25 may store therein a transformed image obtained by performing the perspective projection transformation of a fisheye image or may store both of the panorama transformation data and the transformed image. In this embodiment, a transformed image is a panorama image obtained by performing panorama development on a fisheye image. The panorama transformation data accumulator 25 may also store therein the details of inverse transformation of the perspective projection transformation performed on a fisheye image, that is, transformation from a panorama image to a fisheye image. The annotation data accumulator 26 stores therein information regarding annotation performed on a fisheye image or other images.

The controller 21 controls the communication unit 22 and the data accumulator 23. The controller 21 causes each of the untransformed-image data accumulator 24, the panorama transformation data accumulator 25, and the annotation data accumulator 26 of the data accumulator 23 to store corresponding data transferred from the annotation relay 10 through the communication unit 22. In addition, in response to a request from the annotation relay 10 through the communication unit 22, the controller 21 causes each of the untransformed-image data accumulator 24, the panorama transformation data accumulator 25, and the annotation data accumulator 26 to extract and transmit the corresponding data.

The annotation relay 10 may be an independent apparatus or may be incorporated into an information processing apparatus such as a computer or into another apparatus. The annotation relay 10 includes a controller 11, a first communication unit 12, a second communication unit 13, an image transformer 14, a coordinate transformer 15, and an input unit 16. The controller 11 performs overall control of the annotation relay 10. The input unit 16 receives various inputs of an instruction and the like.

The first communication unit 12 communicates with the communication unit 22 of the server 20 through the communication network such as the Internet. The first communication unit 12 may be a communication circuit including a communication interface. For example, a wireless LAN such as Wi-Fi (registered trademark) may be used for the communication between the first communication unit 12 and the server 20. Wired communication using a cable may also be performed. Other wireless or wired communications may also be performed. A router that is a communication device that relays communication between the first communication unit 12 and the communication unit 22 may be disposed therebetween and may relay the communication between the first communication unit 12 and the communication network.

The second communication unit 13 communicates with the annotation apparatus 30. The second communication unit 13 may be a communication circuit including a communication interface. The communication between the second communication unit 13 and the annotation apparatus 30 may be performed through a communication network such as the Internet, as in the first communication unit 12. A mobile communication standard used in a mobile communication system, such as third generation mobile communication (3G), fourth generation mobile communication (4G), or Long Term Evolution (LTE) (registered trademark), may also be used for the communication between the second communication unit 13 and the annotation apparatus 30.

The image transformer 14 generates a panorama image by performing perspective projection transformation of a fisheye image under the control of the controller 11. The coordinate transformer 15 performs coordinate transformation of annotation information under the control of the controller 11 to make the annotation information applicable to a fisheye image or a panorama image. For example, the coordinate transformer 15 performs coordinate transformation of the information regarding annotation set for a panorama image to make the information applicable to the coordinate system of a fisheye image that is the original image yet to be transformed into the panorama image. The coordinate transformer 15 then associates the information with the fisheye image. In this case, under the control of the controller 11, the coordinate transformer 15 acquires fisheye image data from the untransformed-image data accumulator 24 of the server 20 and transmits the panorama image and/or the details of the perspective projection transformation to the panorama transformation data accumulator 25 of the server 20.

The annotation apparatus 30 is capable of exchanging information with the annotation relay 10. The annotation apparatus 30 may be an information processing apparatus such as a computer, a mobile phone, or a mobile terminal such as a smartphone, a smartwatch, a tablet, or a small personal computer. The annotation apparatus 30 includes a controller 31, a communication unit 32, a display unit 33, and an input unit 34. The controller 31 performs overall control of the annotation apparatus 30. The communication unit 32 may be a communication circuit including a communication interface. The communication unit 32 communicates with the second communication unit 13 of the annotation relay 10 as described above.

The display unit 33 may be configured of, for example, a liquid crystal panel or an organic or inorganic electro-luminescence (EL) panel. The input unit 34 receives various inputs of an instruction and the like. The input unit 34 may be provided separately from the display unit 33 or may be integral with the display unit 33 to allow input based on a touch on the display unit 33, like a touch panel.

The components that are the controller 21 of the server 20, the controller 11 of the annotation relay 10, and the image transformer 14, the coordinate transformer 15, and the controller 31 of the annotation apparatus 30 may each be configured of dedicated hardware or may be implemented by running a software program suitable for the corresponding component. In this case, each component may include, for example, a processor (not illustrated) and a storage (not illustrated) that stores a control program. Examples of the processor include a micro processing unit (MPU) and a central processing unit (CPU). Examples of the storage include a memory. Note that each component may be configured of an independent component that performs centralized control or a plurality of components that perform distributed control in cooperation with each other. The software program may be provided as an application through communication performed via a communication network such as the Internet or through communication performed in accordance with a mobile communication standard, or other communication.

Each component may be a circuit such as a large scale integration circuit (LSI) or a system LSI. However, a plurality of components may constitute one circuit or may respectively constitute circuits. In addition, the circuits may be general-purpose circuits or dedicated circuits.

The system LSI is a super multifunction LSI obtained by integrating a plurality of elements into one chip. Specifically, the system LSI is a computer system including a microprocessor, a read-only memory (ROM), a random-access memory (RAM), and other components. The RAM stores therein computer programs. The microprocessor operates in accordance with a computer program, and the system LSI implements the function. The system LSI and the LSI may be a field programmable gate array (FPGA) that is programmable after the LSI is manufactured and may include a reconfigurable processor capable of reconfiguring the connection and setting of circuit cells in the LII.

Some or all of the components may be configured of an attachable/detachable integrated circuit (IC) card or a separate module. The IC card or the module is a computer system including a microprocessor, a ROM, a RAM, and other components. The IC card or the module may include the LSI or the system LSI. The microprocessor operates in accordance with a computer program, and the IC card or the module thereby implements the function. The IC card or the module may be tamper-resistant.

### Annotation System Operation

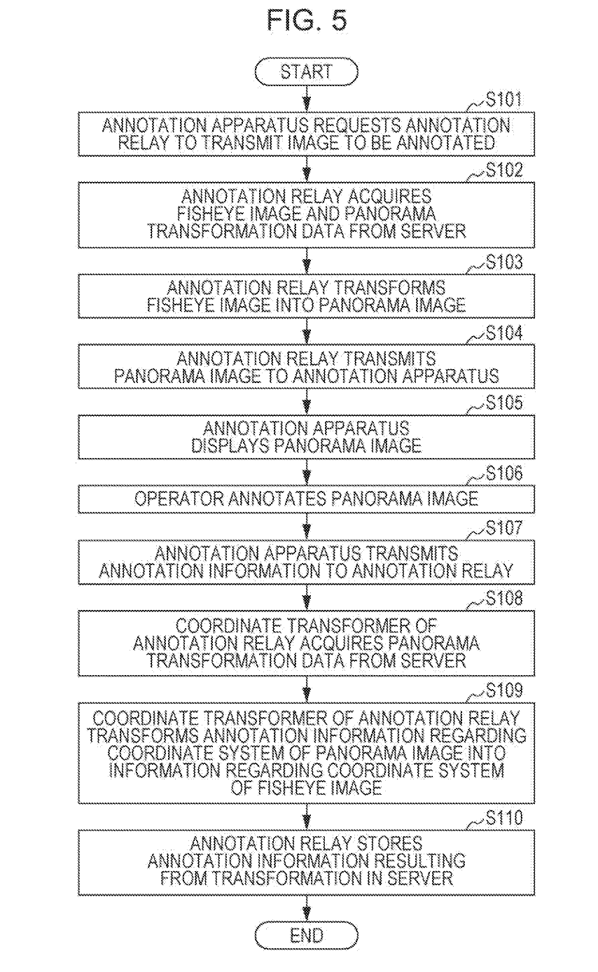

The operation of the annotation system 100 will be described with reference to FIGS. 4 and 5. FIG. 5 is a flowchart illustrating the operation of the annotation system 100 according to the embodiment. In this embodiment, the annotation relay 10 is operated by a data constructor who constructs a large volume of learning image data for machine learning including deep learning, such as for a neural network. The server 20 may also be operated by the data constructor or a party other than the data constructor. If the server 20 is operated by the party other than the data constructor, the server 20 may be configured as a cloud system.

A fisheye image is stored in the untransformed-image data accumulator 24 of the server 20 by using an apparatus different from the annotation relay 10. For example, in the annotation system 100, an image provider who has a contract with the data constructor transmits a fisheye image such as video captured with a monitoring camera, an onboard camera, or the like to the untransformed-image data accumulator 24. In this case, if the server 20 is configured as the cloud system, the fisheye image is stored easily.

The annotation apparatus 30 is operated by a party other than the data constructor. An operator of the annotation apparatus 30 has an annotation contract with the data constructor and annotates an image provided by the data constructor. That is, the operator of the annotation apparatus 30 is an annotation operator.

In the operation of the annotation system 100, in accordance with an instruction input to the input unit 34 by the operator, the annotation apparatus 30 requests the annotation relay 10 to transmit an image to be annotated (step S101). The controller 11 of the annotation relay 10 having received the request requests the untransformed-image data accumulator 24 of the server 20 to transmit a fisheye image and an image identification (ID) set for the fisheye image, requests the panorama transformation data accumulator 25 to transmit panorama transformation data corresponding to the image ID, and acquires these (step S102).

The controller 11 of the annotation relay 10 causes the image transformer 14 to perform perspective projection transformation of the fisheye image based on the panorama transformation data and to generate a panorama image (step S103). For example, the image transformer 14 transforms the fisheye image illustrated in FIG. 1 into the panorama image illustrated in FIG. 2. Further, the image transformer 14 associates the transformed panorama image with the image ID set in the fisheye image. The controller 11 then transmits the panorama image associated with the image ID to the annotation apparatus 30 (step S104).

The annotation apparatus 30 displays the panorama image received from the annotation relay 10 on the display unit 33 (step S105). The operator operates the input unit 34 and annotates entities included in the panorama image displayed on the display unit 33 (step S106). The entities may be, for example, persons. The operator, for example, as illustrated in FIG. 2, surrounds each person with a rectangular frame and sets the area of the entity to be annotated. Regardless of whether a touch panel is used as the input unit 34 or a mouse or a keyboard is used, the rectangular frame can be set easily. Note that it is desirable not to include any object other than the target person in the rectangular frame.

Every time the operator surrounds the corresponding person in the panorama image with the rectangular frame, information regarding the rectangular frame, that is, annotation information together with the image ID of the annotated panorama image is transmitted to the annotation relay 10 (step S107). The shape of the area of the entity to be annotated is not limited to a rectangle, and the area may be of any shape. The operation for setting the area is not limited to surrounding the area and may be any operation. For example, a square area may be set in such a manner that the operator specifies the locations of the four corners.

In the panorama image in FIG. 2, the transmitted annotation information is information using the coordinate system having the X1 and Y1 axes that are set in the panorama image. For example, the annotation information may include the attributes of the person included in the rectangular frame, the coordinates of a point P at the upper left corner of the rectangular frame, the width of the rectangular frame in the X1-axis direction with respect to the point P, and the height of the rectangular frame in Y1-axis direction with respect to the point P. The attribute of the person can include sex, physical constitution, age group, and the like of the person. For example, the annotation information can include encoded or numerically expressed elements (the attribute of the entity and the coordinates, the width, and the height with respect to the point P).

Upon receiving the annotation information and the image ID, the controller 11 of the annotation relay 10 causes the coordinate transformer 15 to perform coordinate transformation to make the annotation information regarding the panorama image applicable to the fisheye image. At this time, the coordinate transformer 15 acquires panorama transformation data corresponding to the received image ID from the panorama transformation data accumulator 25 of the server 20 (step S108).

Based on the acquired panorama transformation data, the coordinate transformer 15 transforms information regarding the coordinate system of the panorama image in the annotation information, for example, the coordinate system having the X1 and Y1 axes into information regarding the coordinate system of the fisheye image (step S109). The coordinate system of the fisheye image may be a polar coordinate system with the center Ac serving as the origin as illustrated in FIG. 3 or an orthogonal coordinate system based on two mutually orthogonal linear axes. At this time, the coordinate transformer 15 associates the annotation information resulting from the coordinate transformation with the image ID. Note that the panorama transformation data acquired in step S108 may be data regarding transformation from the fisheye image to the panorama image or from the panorama image to the fisheye image. If the panorama transformation data is data regarding transformation from the fisheye image to the panorama image, the coordinate transformer 15 may perform inverse transformation by using the panorama transformation data and thereby transform the coordinate system of the panorama image to the coordinate system of the fisheye image.

The controller 11 transmits the annotation information resulting from the coordinate transformation performed by the coordinate transformer 15 together with the image ID to the annotation data accumulator 26 of the server 20 and causes the annotation data accumulator 26 to store, that is, to record the annotation information therein (step S110). The annotation information made applicable to the fisheye image is thereby stored in the annotation data accumulator 26. Accordingly, the fisheye image and the annotation information regarding the fisheye image can be used directly as learning image data for a neural network.

Note that in the case where the panorama transformation data accumulator 25 stores a panorama image therein, the controller 11 of the annotation relay 10 may acquire a panorama image from the panorama transformation data accumulator 25 in steps S102 and S103. The coordinate transformer 15 of the annotation relay 10 may acquire the panorama image and a fisheye image corresponding to the panorama image in step S108 and may perform the coordinate transformation based on the relationship between the panorama image and the fisheye image in step S109.

### Modification 1 of Annotation System Operation

Hereinafter, Modification 1 of the operation of the annotation system 100 will be described. When the annotation apparatus 30 requests an annotation target image, the annotation relay 10 provides a panorama image in the embodiment. However, in this modification, the annotation apparatus 30 can select one of a fisheye image and a panorama image as an image to be provided. Hereinafter, differences in this modification from the embodiment will mainly be described.

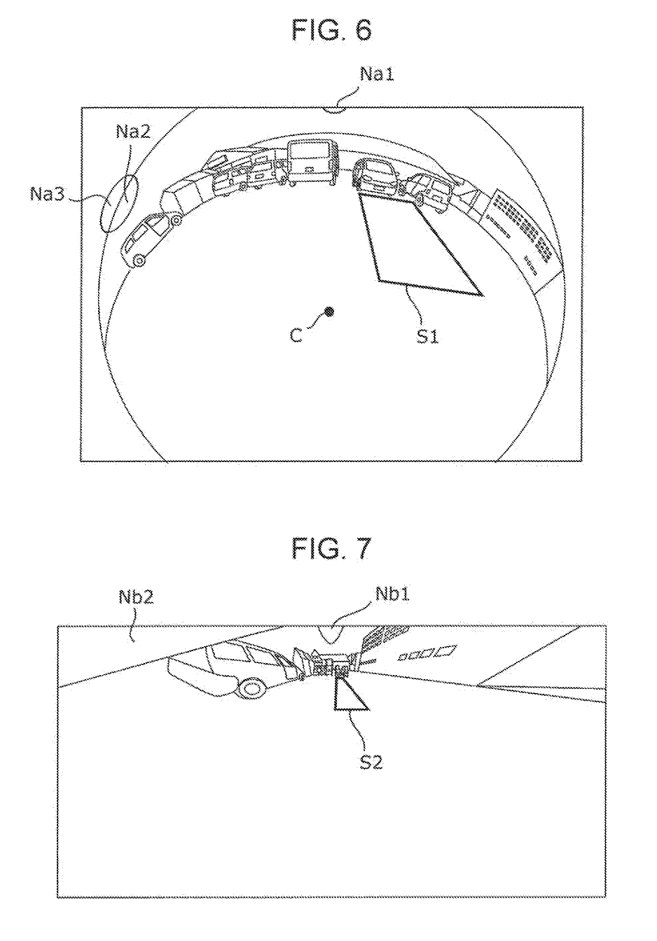

FIGS. 6 and 7 illustrate an example in which the same entity is to be annotated by using a frame surrounding the area of the entity in a fisheye image and a panorama image corresponding to the fisheye image. Note that in FIGS. 6 and 7, the entity is a car parking space. FIG. 6 is a diagram illustrating annotation to be performed on a fisheye image of a parking lot captured with an onboard camera that is an omnidirectional video camera. FIG. 7 is a diagram illustrating annotation that is the same as the annotation in FIG. 6 and that is to be performed on the panorama image obtained by performing perspective projection transformation of the fisheye image in FIG. 6.

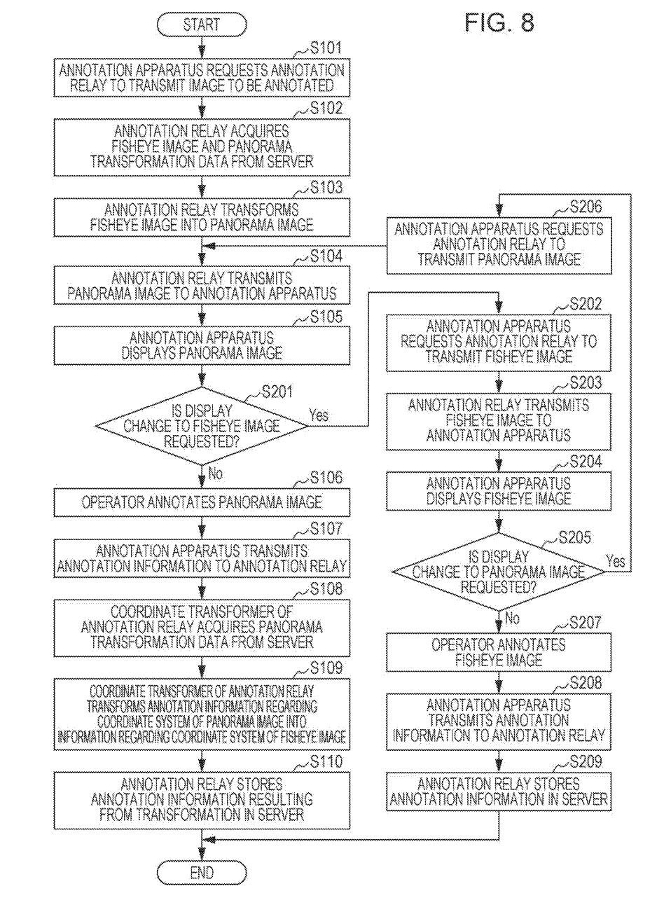

In the fisheye image in FIG. 6, an area S1 that is a parking space to be annotated has a trapezoidal shape. In the panorama image in FIG. 7, an area S2 that is a parking space to be annotated has a trapezoidal shape considerably smaller and narrower than the area S1. Accordingly, compared with using the panorama image, using the fisheye image makes it easier for the annotation operator to specify and annotate the entity by surrounding the area of the parking space in the image. In this modification, when performing an annotation operation, the annotation operator can perform switching between the fisheye image and the panorama image and thereby can select one of the fisheye image and the panorama image to be displayed on the display unit 33 of the annotation apparatus 30. Specifically, the annotation system 100 performs an annotation operation as illustrated in FIG. 8. FIG. 8 is a flowchart illustrating the operation of the annotation system 100 according to Modification 1.

First, the annotation relay 10 and the annotation apparatus 30 perform steps S101 to S105 in the same manner as in the embodiment. The panorama image is thereby displayed on the display unit 33 of the annotation apparatus 30. If the input unit 34 of the annotation apparatus 30 receives a request for changing a displayed image from the panorama image to a fisheye image in step S201 following step S105 (Yes in step S201), the annotation apparatus 30 proceeds to step S202. If the input unit 34 does not receive a change request (No in step S201), the annotation apparatus 30 proceeds to step S106. After step S106, the annotation relay 10 and the annotation apparatus 30 perform steps S107 to S110 in the same manner as in the embodiment.

In step S202, the annotation apparatus 30 requests the annotation relay 10 to transmit the fisheye image corresponding to the received panorama image. The controller 11 of the annotation relay 10 requests and acquires the fisheye image from the untransformed-image data accumulator 24 of the server 20 and transmits the fisheye image to the annotation apparatus 30 (step S203). The controller 11 of the annotation relay 10 may temporarily store the fisheye image acquired in step S102 in the memory (not illustrated) or the like of the controller 11 and may use the stored fisheye image in step S203. The annotation apparatus 30 displays the fisheye image received from the annotation relay 10 on the display unit 33 (step S204).

If the input unit 34 of the annotation apparatus 30 receives a request for changing the displayed image from the fisheye image to the panorama image in step S205 following step S204 (Yes in step S205), the annotation apparatus 30 proceeds to step S206. If the input unit 34 does not receive the change request (No in step S205), the annotation apparatus 30 proceeds to step S207.

In step S206, the annotation apparatus 30 requests the annotation relay 10 to transmit the panorama image. In step S104 following step S206, the annotation relay 10 transmits the panorama image stored in the memory (not illustrated) or the like to the annotation apparatus 30. However, if the annotation relay 10 has not temporarily stored the panorama image, the annotation relay 10 may perform steps S102 and S103 again and generate the panorama image.

In step S207, the operator operates the input unit 34 of the annotation apparatus 30 and annotates an entity included in the fisheye image displayed on the display unit 33. Every time the operator annotates an entity in the fisheye image, annotation information together with the image ID of the annotated fisheye image is transmitted to the annotation relay 10 (step S208). Further, the annotation relay 10 transmits the received annotation information together with the image ID to the annotation data accumulator 26 of the server 20 and causes the annotation data accumulator 26 to store, that is, to record the annotation information and the image ID (step S209).

In the operation of the annotation system 100 according to Modification 1 described above, the annotation relay 10 transmits the panorama image as the first image transmitted to the annotation apparatus 30 in step S104, but the first transmitted image is not limited to the panorama image. The annotation relay 10 may transmit the fisheye image first and thus cause the annotation apparatus 30 to display the fisheye image. The annotation relay 10 may also transmit the fisheye image and the panorama image first and thus cause the annotation apparatus 30 to display the fisheye image and the panorama image simultaneously.

In the operation of the annotation system 100 according to Modification 1 described above, the same step as step S201 or S205 may be performed with the input unit 34 of the annotation apparatus 30 before the annotation operation is completed in step S106 or S207. Further, when the panorama image displayed on the display unit 33 of the annotation apparatus 30 is switched to the fisheye image, or when the fisheye image displayed on the display unit 33 is switched to the panorama image, the area, for example, the area S1 or S2 in FIG. 6 or 7, of the annotation set for the entity before the switching may be displayed in the panorama image or the fisheye image displayed after the switching. This enables the operator to select an image to be annotated in accordance with the entity and annotate the image without repeating the annotation.

### Modification 2 of Annotation System Operation

Hereinafter, Modification 2 of the operation of the annotation system 100 will be described. In the operation of the annotation system 100 according to Modification 2, the annotation apparatus 30 determines the appropriateness of the area of an entity to be set in the annotation operation in each of steps S106 and S207 in Modification 1. Hereinafter, differences in this modification from the embodiment and Modification 1 will mainly be described.

With reference to FIG. 6, the fisheye image illustrated therein has a rectangular outer shape and is an image captured with a diagonal fisheye lens. After such a fisheye image is transformed into a panorama image, the panorama image illustrated in FIG. 7 is obtained. In this panorama image, pixels are not present, for example, in two areas Nb1 and Nb2, that is, the pixels are not displayed. The area Nb1 corresponds to an area Na1 in the central top part of the fisheye image in FIG. 6. When being generated in the perspective projection transformation from a fisheye image to a panorama image, the area Nb1 includes the area Na1 inside the fisheye image and an area outside the fisheye image and neighboring the area Na1 and has a considerably reduced amount of information. Accordingly, the area Nb1 is displayed as if the pixels were not present in the panorama image. Likewise, the area Nb2 corresponds to an area Na2 near a border between an area where a captured image part of the fisheye image in FIG. 6 is displayed and a neighboring area that is not displayed. Accordingly, when being generated in the perspective projection transformation from the fisheye image to the panorama image, the area Nb2 includes the area Na2 and an area Na3 not displayed and neighboring the area Nb2 and has a considerably reduced amount of information. The area Nb2 is thus displayed as if the pixels were not present in the panorama image. That is, the areas Nb1 and Nb2 in the panorama image might have been displayed in the fisheye image.

Accordingly, if the operator performs an annotation operation on an area such as the area Nb1 or Nb2 in FIG. 7 in the panorama image in step S106 in FIG. 8, the controller 31 of the annotation apparatus 30 executes a process for displaying the fisheye image corresponding to the panorama image on the display unit 33. The process for changing the displayed image from the panorama image to the fisheye image is the same as the process described in Modification 1.

In addition, if the operator performs an annotation operation on an area such as the area Na3 in FIG. 6 in the fisheye image in step S207 in FIG. 8, the controller 31 of the annotation apparatus 30 gives an alarm via the display unit 33 and/or a sound generator (not illustrated). As described above, an area not displayed in a panorama image might be displayed in a fisheye image. However, an area not displayed in a fisheye image is not displayed in a panorama image either. The controller 31 of the annotation apparatus 30 may indicate, as an approximation candidate, the area Na2 that is an area where the captured image part neighboring the area Na3 is displayed. Note that the area Na2 adjoins the area Na3 and is located inside the fisheye image in the radial direction with a center C located in the center of the fisheye image and is an area approximate to the area Na3,

### Advantageous Effects and Others

As described above, the annotation system 100 according to the embodiment is an annotation system for a fisheye image. The annotation system 100 includes the controller 11 serving as an acquirer that acquires a fisheye image stored in the untransformed-image data accumulator 24 serving as a first data storage, the image transformer 14 that generates a transformed image by performing perspective projection transformation of the fisheye image, the controller 11 serving as a presenter that transmits the transformed image to the annotation apparatus 30 serving as an apparatus of an operator who performs annotation, the controller 11 serving as the receiver that receives, from the annotation apparatus 30, annotation information regarding annotation performed on the transformed image by using the annotation apparatus 30, the coordinate transformer 15 that performs transformation of coordinate information included in the annotation information and regarding the annotation in the transformed image into information regarding coordinates in the fisheye image, and the controller 11 serving as a recorder that records, in the annotation data accumulator 26 serving as a second data storage, the annotation information resulting from the transformation as fisheye-image annotation information regarding the annotation in the fisheye image. Note that the transformed image may be a panorama image obtained by performing panorama development transformation of the fisheye image.

In the aforementioned configuration, a fisheye image is first transformed into a transformed image, and annotation is performed on the transformed image. Further, annotation information regarding the performed annotation is transformed to be applicable to coordinates in the fisheye image. An annotation operation is thereby performed on the transformed image and can thus be easily performed. The annotation information transformed to be applicable to the coordinates in the fisheye image can be used directly as information regarding learning image data for identifying and detecting an entity in the fisheye image. Accordingly, performing annotation on the fisheye image is simplified, and the annotation is easily used.

The annotation system 100 according to the embodiment further includes the server 20 that includes the untransformed-image data accumulator 24 and the annotation data accumulator 26 and that communicates with the controller 11 serving as the acquirer and the recorder. The annotation system 100 according to the embodiment further includes the annotation relay 10 that relays information between the untransformed-image data accumulator 24 and the annotation apparatus 30 and between the annotation data accumulator 26 and the annotation apparatus 30. The annotation relay 10 includes the controller 11 serving as the acquirer, the presenter, the receiver, and the recorder, the image transformer 14, and the coordinate transformer 15.

In the aforementioned configuration, providing the untransformed-image data accumulator 24 that accumulates a large volume of data and the annotation data accumulator 26 separately from the controller 11 enables downsizing of the annotation relay 10 that is an apparatus including the controller 11. Further, an image data constructor using the annotation system 100 can use apparatuses operated by a party other than the data constructor, as the annotation apparatus 30 and the server 20. For example, the annotation apparatus 30 may be an apparatus of a party to an annotation contract with the data constructor, and the server 20 may be a cloud server. This enables simplification of the configuration of the annotation system 100.

In the annotation system 100 according to one of the modifications of the embodiment, the controller 11 serving as the presenter receives, from the annotation apparatus 30, an instruction for selecting one of the fisheye image and the transformed image as an image to be presented and transmits a selected image to the annotation apparatus 30, and the controller 11 serving as the receiver receives, from the annotation apparatus 30, annotation information regarding annotation performed on the selected image by using the annotation apparatus 30. In addition, if the selected image is the transformed image, the coordinate transformer 15 performs transformation of the coordinate information included in the annotation information and regarding the annotation in the transformed image into the information regarding the coordinates in the fisheye image, and the controller 11 serving as the recorder records, in the annotation data accumulator 26, the annotation information resulting from the transformation as the fisheye-image annotation information. If the selected image is the fisheye image, the coordinate transformer 15 regards the annotation information as the fisheye-image annotation information, and the controller 11 serving as the recorder records the annotation information in the annotation data accumulator 26.

In the aforementioned configuration, the operator who performs an annotation operation with the annotation apparatus 30 may select one of the fisheye image and the transformed image as an image to be annotated more easily than the other. The annotation operation can thus be simplified.

The annotation system 100 according to one of the modifications of the embodiment includes the controller 11 serving as a notifier. If the annotation information regarding the annotation performed on the transformed image that is the selected image includes a first area of the transformed image, the controller 11 transmits the fisheye image instead of the transformed image to the annotation apparatus 30. If the annotation information regarding the annotation performed on the fisheye image that is the selected image includes a second area of the fisheye image, the controller 11 notifies the annotation apparatus 30 of an alarm or an approximate area for the annotation. Note that the first area may be an area that is displayed in the fisheye image but that is not displayed in the transformed image, and the second area may be an area that is not displayed in the fisheye image.

In the aforementioned configuration, if perspective projection transformation from a fisheye image to a transformed image is performed, the transformed image includes a conspicuously distorted part formed from the fisheye image. Such a part is displayed in the fisheye image but is not displayed in the transformed image in some cases. Specifically, the transformed image is likely to have a narrower displayed area than that of the fisheye image. Suppose a case where annotation information regarding annotation performed on the transformed image includes a first area of the transformed image. In this case, even though the first area is not displayed in the transformed image, the first area can be displayed in the fisheye image and be annotated in some cases in such a manner that the transformed image is switched to the fisheye image to be displayed by the annotation apparatus 30. Also suppose a case where annotation information regarding annotation performed on the fisheye image includes a second area of the fisheye image. In this case, if the second area is not displayed in the fisheye image, the second area is not displayed in the transformed image either. Accordingly, if the fisheye image includes a not displayed part in the area set for the annotation, notifying an alarm or an approximate area for the annotation enables the not displayed part not to be included in the area set for the annotation. If the not displayed part is included in the area set for the annotation, an entity might not be identified properly in the image.

An annotation method according to the embodiment is an annotation method for a fisheye image. In this method, a fisheye image is acquired, a transformed image is generated by performing perspective projection transformation of the fisheye image, the transformed image is presented to an operator who performs annotation, input of annotation information regarding annotation performed on the transformed image is received from the operator, transformation of coordinate information included in the input annotation information and regarding the annotation in the transformed image into information regarding coordinates in the fisheye image is performed, and the annotation information resulting from the transformation is recorded as fisheye-image annotation information regarding the annotation in the fisheye image. Further, the transformed image may also be a panorama image obtained by performing panorama development transformation of the fisheye image.

In the annotation method according to one of the modifications of the embodiment, input for selecting one of the fisheye image and the transformed image as an image to be presented is received from the operator, a selected image is presented to the operator, and input of annotation information regarding annotation performed on the selected image is received from the operator. In addition, if the selected image is the transformed image, the transformation of the coordinate information included in the input annotation information and regarding the annotation in the transformed image into the information regarding the coordinates in the fisheye image is performed, and the annotation information resulting from the transformation is recorded as the fisheye-image annotation information. If the selected image is the fisheye image, the input annotation information is recorded as the fisheye-image annotation information.

In the annotation method according to one of the modifications of the embodiment, when input of the annotation information regarding the annotation performed on the transformed image is received from the operator, and if the input annotation information includes a first area of the transformed image, the fisheye image instead of the transformed image is presented to the operator. When input of annotation information regarding annotation performed on the fisheye image is received from the operator, and if the input annotation information includes a second area of the fisheye image, an alarm or an approximate area for the annotation is presented to the operator. Further, the first area may be an area that is displayed in the fisheye image but that is not displayed in the transformed image, and the second area may be an area that is not displayed in the fisheye image.

Each method described above exerts the same advantageous effects as those exerted by the annotation system 100 according to the embodiment and the modifications. The method may be implemented by a MPU, a CPU, a processor, a circuit such as a LSI, an IC card, a separate module, or the like.

The processing in the embodiment and the modifications may be implemented by a software program or digital signals generated by the software program. For example, the processing in the embodiment is implemented by a program as described below.

Specifically, in the program, a fisheye image is acquired, a transformed image is generated by performing perspective projection transformation of the fisheye image, the transformed image is presented to an apparatus of an operator who performs annotation, input of annotation information regarding annotation performed on the transformed image is received from the apparatus of the operator, transformation of coordinate information included in the input annotation information and regarding the annotation in the transformed image into information regarding coordinates in the fisheye image is performed, and the annotation information resulting from the transformation is recorded as fisheye-image annotation information regarding the annotation in the fisheye image.

Note that the program and the digital signals generated by the program may be recorded in a computer readable recording medium such as a flexible disk, a hard disk, a compact disc read-only memory (CD-ROM), a magneto-optical disc (MO), a digital versatile disk (DVD), a DVD-ROM, a DVD-RAM, a Blue-ray (registered trademark) disc (BD), or a semiconductor memory.

The program and the digital signals generated by the program may be transmitted through a telecommunication network, a wireless or wired communication network, a network represented by the Internet, data broadcasting, or the like. The program and the digital signals generated by the program may also be implemented by a different independent computer system in such a manner as to be transferred with being recorded in a recording medium or through a network or the like,

### Other Modifications

The embodiment and the modifications have heretofore been described as examples of the technology disclosed in the present application. However, the technology in the present disclosure is not limited to the above-described embodiment and modifications and is applicable to a modification of the embodiment or another embodiment resulting from a modification, a replacement, an addition, an omission, or the like appropriately made to this embodiment. In addition, the components described in the embodiment and the modifications may be combined to result in a new embodiment or a new modification. The fisheye lens according to the embodiment and the modifications may be a free-form lens. The perspective projection transformation according to the embodiment and the modifications may be distortion correction performed by transforming a lens parameter.

The server 20, the annotation relay 10, and the annotation apparatus 30 are separate components and arranged away from each other in the annotation system 100 according to the embodiment and the modifications but are not limited to this configuration. For example, the server 20 and the annotation relay 10 may constitute one apparatus, and the annotation relay 10 and the annotation apparatus 30 may constitute one apparatus.

The annotation system 100 according to the embodiment and the modifications is used to construct a large volume of learning image data for a neural network such as for deep learning but is not limited to this use. The annotation system 100 may be applied to any configuration for constructing image data. In the annotation system 100 according to the embodiment and the modifications, image data yet to be transformed is a fisheye image but is not limited to the fisheye image. The image data yet to be transformed may be, for example, an image captured with an omnidirectional camera.

Note that general and specific aspects of the present disclosure may be implemented as a system, a method, an integrated circuit, a computer program, a recording medium such as a computer readable CD-ROM, or any selective combination thereof.

The embodiment and the modifications have heretofore been described as examples of the technology in the present disclosure, and the attached drawings and detailed description have thus been provided. Accordingly, to describe the technology as an example, the components described in the attached drawings and the detailed description may include not only components needed to solve a problem but also components not needed to solve the problem. The description of the not needed components in the attached drawings and the detailed description should not be considered to indicate that the not needed components are in fact needed. Since the embodiment and the modifications described above are provided for exemplifying the technology in the present disclosure, various modifications, replacements, additions, omissions, and the like may be made without departing from the scope of claims and their equivalents.

The present disclosure is usable for technology for annotating a fisheye image.

What is claimed is:

1. An annotation method for a fisheye image, the method comprising:
acquiring a fisheye image;
generating a transformed image by performing perspective projection transformation of the fisheye image;
presenting the transformed image to an operator who performs annotation;
receiving, from the operator, input of annotation information regarding annotation performed on the transformed image;
performing transformation of coordinate information included in the input annotation information and regarding the annotation in the transformed image into information regarding coordinates in the fisheye image, and
recording the annotation information resulting from the transformation as fisheye-image annotation information regarding the annotation in the fisheye image.

2. The annotation method according to claim 1,
wherein input for selecting one of the fisheye image and the transformed image as an image to be presented is received from the operator,
wherein a selected image is presented to the operator,
wherein input of annotation information regarding annotation performed on the selected image is received from the operator,
wherein if the selected image is the transformed image, the transformation of the coordinate information included in the input annotation information and regarding the annotation in the transformed image into the information regarding the coordinates in the fisheye image is performed, and
the annotation information resulting from the transformation is recorded as the fisheye-image annotation information, and
wherein if the selected image is the fisheye image, the input annotation information is recorded as the fisheye-image annotation information.

3. The annotation method according to claim 2,
wherein when input of the annotation information regarding the annotation performed on the transformed image is received from the operator, and if the input annotation information includes a first area of the transformed image, the fisheye image instead of the transformed image is presented to the operator, and
wherein when input of annotation information regarding annotation performed on the fisheye image is received from the operator, and if the input annotation information includes a second area of the fisheye image, an alarm or an approximate area for the annotation is presented to the operator.

4. The annotation method according to claim 3,
wherein the first area is an area that is displayed in the fisheye image but that is not displayed in the transformed image, and
wherein the second area is an area that is not displayed in the fisheye image.

5. The annotation method according to claim 1,
wherein the transformed image is a panorama image obtained by performing panorama development transformation of the fisheye image.

6. An annotation system for a fisheye image, the annotation system comprising:
an acquirer that acquires a fisheye image stored in a first data storage;
an image transformer that generates a transformed image by performing perspective projection transformation of the fisheye image;
a presenter that transmits the transformed image to an apparatus of an operator who performs annotation;
a receiver that receives, from the apparatus of the operator, annotation information regarding annotation performed on the transformed image by using the apparatus of the operator;
a coordinate transformer that performs transformation of coordinate information included in the annotation information and regarding the annotation in the transformed image into information regarding coordinates in the fisheye image; and
a recorder that records, in a second data storage, the annotation information resulting from the transformation as fisheye-image annotation information regarding the annotation in the fisheye image.

7. The annotation system according to claim 6, further comprising
a server that includes the first data storage and the second data storage and that communicates with the acquirer and the recorder.

8. The annotation system according to claim 6,
further comprising
an annotation relay that relays information between the first data storage and the apparatus of the operator and between the second data storage and the apparatus of the operator,
wherein the annotation relay includes the acquirer, the image transformer, the presenter, the receiver, the coordinate transformer, and the recorder.

9. The annotation system according to claim 6,
wherein the presenter receives, from the apparatus of the operator, an instruction for selecting one of the fisheye image and the transformed image as an image to be presented and transmits a selected image to the apparatus of the operator,
wherein the receiver receives, from the apparatus of the operator, annotation information regarding annotation performed on the selected image by using the apparatus of the operator,
wherein if the selected image is the transformed image, the coordinate transformer performs transformation of the coordinate information included in the annotation information and regarding the annotation in the transformed image into the information regarding the coordinates in the fisheye image, and
the recorder records, in the second data storage, the annotation information resulting from the transformation as the fisheye-image annotation information, and
wherein if the selected image is the fisheye image, the coordinate transformer regards the annotation information as the fisheye-image annotation information, and
the recorder records the annotation information in the second data storage.

10. The annotation system according to claim 9,
further comprising
a notifier,
wherein if the annotation information regarding the annotation performed on the transformed image that is the selected image includes a first area of the transformed image, the notifier transmits the fisheye image instead of the transformed image to the apparatus of the operator, and
wherein if the annotation information regarding the annotation performed on the fisheye image that is the selected image includes a second area of the fisheye image, the notifier notifies the apparatus of the operator of an alarm or an approximate area for the annotation.

11. The annotation system according to claim 10,
wherein the first area is an area that is displayed in the fisheye image but that is not displayed in the transformed image, and
wherein the second area is an area that is not displayed in the fisheye image.

12. The annotation system according to claim 6,
wherein the transformed image is a panorama image obtained by performing panorama development transformation of the fisheye image.

13. A non-transitory computer-readable medium storing a program causing a computer to execute an annotation method when the program is run by the computer, the method comprising:
acquiring a fisheye image;
generating a transformed image by performing perspective projection transformation of the fisheye image;
presenting the transformed image to an apparatus of an operator who performs annotation;
receiving, from the apparatus of the operator, input of annotation information regarding annotation performed on the transformed image;
performing transformation of coordinate information included in the input annotation information and regarding the annotation in the transformed image into information regarding coordinates in the fisheye image, and
recording the annotation information resulting from the transformation as fisheye-image annotation information regarding the annotation in the fisheye image
